(19) United States
(12) Patent Application Publication
(10) Pub. No.: US 2011/0116538 A1
(43) Pub. Date: May 19, 2011

(54) VIDEO TRANSMISSION METHOD AND SYSTEM

(75) Inventors: Ming-Kang Chuang, Taipei (TW); Jen-Shin Huang, Taipei (TW)

(73) Assignee: AVERMEDIA INFORMATION, INC., Taipei (TW)

(21) Appl. No.: 12/828,984

(22) Filed: Jul. 1, 2010

(30) Foreign Application Priority Data
Nov. 17, 2009 (TW) 098139007

(51) Int. Cl. H04N 11/04; H04N 7/01

(52) U.S. Cl. 375/240.01; 348/441; 375/E07.026

(57) ABSTRACT

A video transmission method is used with a video data providing device, a first video management device and a second video management device. Firstly, a video coding format supportable by the first video management device is retrieved by the video data providing device. Then, a video image is converted into video data by the video data providing device according to the video coding format, and the video data are transmitted to the second video management device. Afterwards, the video data are transmitted from the second video management device to the first video management device, and the video data are decoded by the first video management device according to the video coding format so as to acquire the video image.

### FIELD OF THE INVENTION

The present invention relates to a video transmission method and a video transmission system, and more particularly to a video transmission method and a video transmission system for retrieving a video coding format by a video data providing device.

### BACKGROUND OF THE INVENTION

Recently, a videoconferencing technique is gradually developed to enable individual users in faraway sites to have meetings or communicate with each other. That is, through a video conference, the users at different cities or countries could discuss with each other in real time. When a video conference is held, the data associated with the environmental image, the files used in the video conference and the operating frame shown in the computer monitor or the electronic whiteboard should be transmitted to the computers of the user terminals through a network in real time. As the demand on the data transmission rate is gradually increased, the network bandwidth becomes more important.

In other words, a plurality of images are transmitted during the video conference. Since the transmission of the images occupy much network bandwidth, the huge data flow rate causes a heavy burden of the network. For solving these drawbacks, a video compression method is disclosed.

FIG. 1 is a schematic functional block diagram illustrating a video transmission system according to the prior art. As shown in FIG. 1, the video transmission system includes a user computer 101, a local video conference device 103 and a remote video conference device 107. The user computer 101 is in communication with the local video conference device 103 through a transmission cable. The local video conference device 103 is in communication with the remote video conference device 107 through a network 105. Firstly, a video image is transmitted from the user computer 101 to the local video conference device 103 through the transmission cable. Then, a video coding format supportable by the remote video conference device 107 is retrieved by the local video conference device 103 through the network 105. Then, the video image is compressed and converted into video data by the local video conference device 103 according to the video coding format. Then, the video data conforming to the video coding format are transmitted to the remote video conference device 107. Then, the video data are decoded by the remote video conference device 107, so that the original video image is restored.

The video transmission method of FIG. 1, however, still has some drawbacks. For example, the user computer 101 is in communication with the local video conference device 103 through the transmission cable. Generally, the distance between the local video conference device 103 and the user computer 101 is not fixed, and more than one user computer 101 is usually connected to the local video conference device 103 through the transmission cable. As more cables are used, the conference room becomes messier. Moreover, since the local video conference device 103 is employed to retrieve the video coding format, and compress and convert the video image into the video data, the burden of the local video conference device 103 is very heavy. Under this circumstance, the video conference is held in an inefficient manner.

Therefore, there is a need of providing an improved video transmission method and system so as to obviate the drawbacks encountered from the prior art.

### SUMMARY OF THE INVENTION

In accordance with an aspect of the present invention, there is provided a video transmission method for use between a video data providing device, a first video management device and a second video management device. Firstly, a video coding format supportable by the first video management device is retrieved by the video data providing device. Then, a video image is converted into video data by the video data providing device according to the video coding format, and the video data are transmitted to the second video management device. Afterwards, the video data are transmitted from the second video management device to the first video management device, and the video data are decoded by the first video management device according to the video coding format so as to acquire the video image.

In accordance with another aspect of the present invention, there is provided a video transmission system for use with a network. The video transmission system includes a first video management device, a second video management device and a video data providing device. The first video management device is in communication with the network and supports a video coding format. The second video management device is in communication with the network. The video data providing device communicates with the first video management device through the second video management device for retrieving the video coding format, converting a video image into video data according to the video coding format, and transmitting the video data to the second video management device. The video data are transmitted from the second video management device to the first video management device. The video data are decoded by the first video management device according to the video coding format so as to acquire the video image.

In accordance with a further aspect of the present invention, there is provided a video data providing device for use with a first video management device and a second video management device. The video data providing device is in communication with the first video management device and the second video management device through a network. The first video management device supports a video coding format. The video data providing device includes a video image generating device and a video data converting device. The video image generating device is used for providing the video image. The video data converting device is in communication with the video image generating device, the first video management device and the second video management device for retrieving the video coding format, converting the video image into the video data according to the video coding format, and transmitting the video data to the second video management device through the network. The video data are transmitted from the second video management device to the first video management device. The video data are decoded by the first video management device according to the video coding format so as to acquire the video image.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a video transmission system according to the prior art;

FIG. 2 is a schematic functional block diagram illustrating a video transmission system according to an embodiment of the present invention;

FIG. 3A is a schematic functional block diagram illustrating the connection between the video data providing device, the second video management device and the first video management device of the video transmission system according to another embodiment of the present invention;

FIG. 3B is a schematic functional block diagram illustrating an exemplary video data providing device of the video transmission system;

FIG. 3C is a schematic functional block diagram illustrating the video data converting device of another exemplary video data providing device of the video transmission system, in which the memory unit is included in the video data converting device;

FIG. 3D is a schematic functional block diagram illustrating the connection between the video data providing device, the second video management device and the first video management device of the video transmission system according to a further embodiment of the present invention; and

FIG. 4 is a flowchart illustrating a video transmission method according to an embodiment of the present invention.

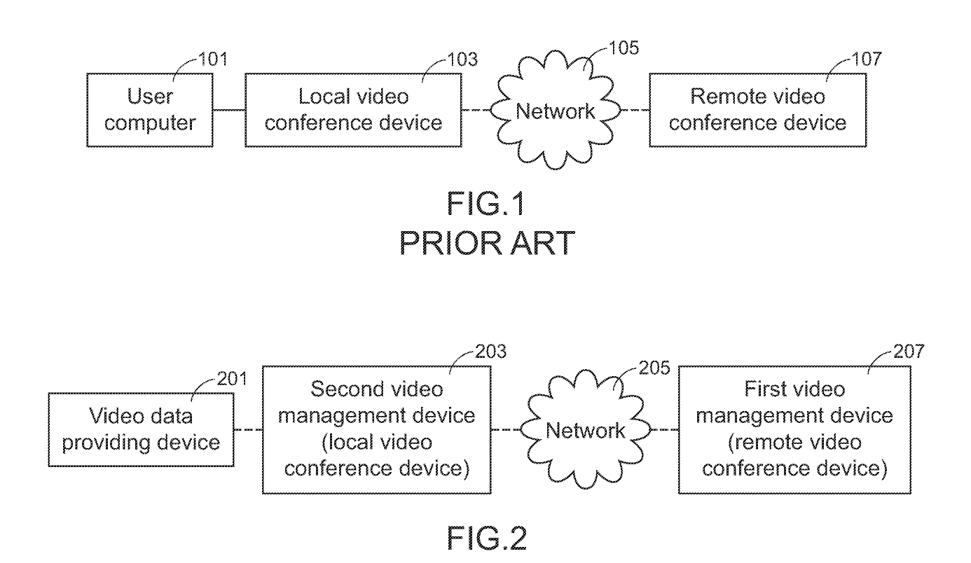

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As previously described, since the local video conference device is employed to retrieve the video coding format, compress the video image and convert the video image into the video data, the burden of the local video conference device is very heavy. For enhancing the data transmission speed and reducing the burden of the local video conference device, the task of converting the video image into the video data is performed by a video data providing device according to the present invention.

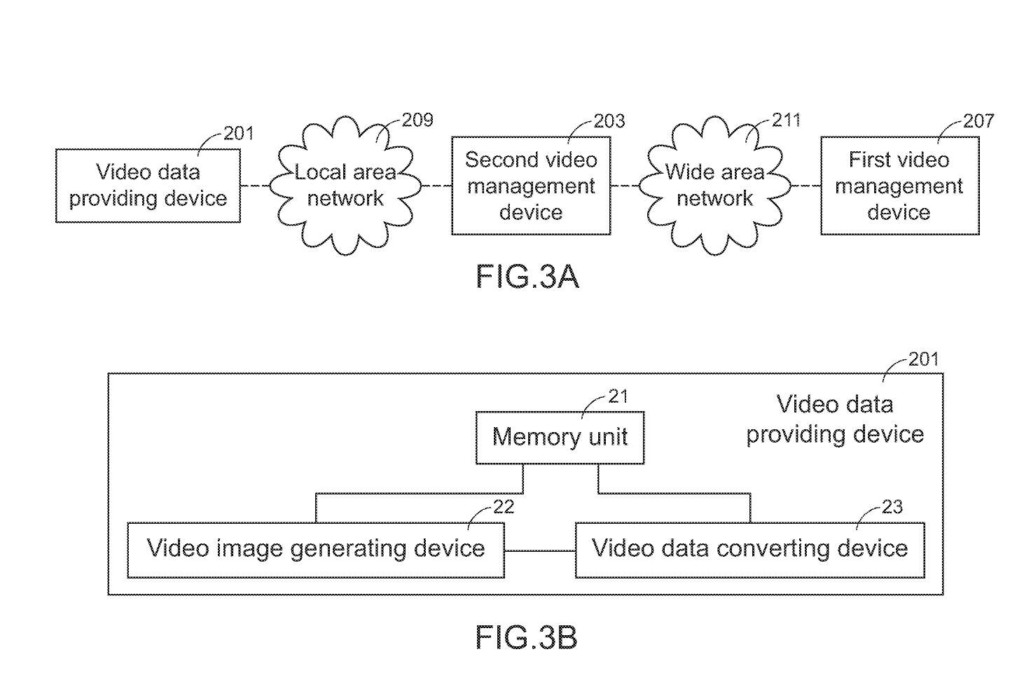

FIG. 2 is a schematic functional block diagram illustrating a video transmission system according to an embodiment of the present invention. The video transmission system includes a video data providing device 201, a first video management device 207 and a second video management device 203. An example of the video data providing device 201 includes but is not limited to a personal computer, a portable electronic device, a camera, an image pickup device, or the like. The first video management device 207 is a remote video conference device. The second video management device 203 is a local video conference device.

Hereinafter, a video transmission method for use with the first video management device 207 and the second video management device 203 will be illustrated with reference to FIG. 2. Firstly, a video coding format supportable by the first video management device 207 is retrieved by the video data providing device 201 through the second video management device 203 and a network 205. Then, a video image which should be transmitted to a remote computer is converted into video data by the video data providing device 201 according to the video coding format, and the video data are transmitted to the first video management device 207 through the second video management device 203. The video data are decoded by the first video management device 207 according to the video coding format, so that the original video image provided by the video data providing device 201 is acquired. The video image may be shown on the remote computer (not shown).

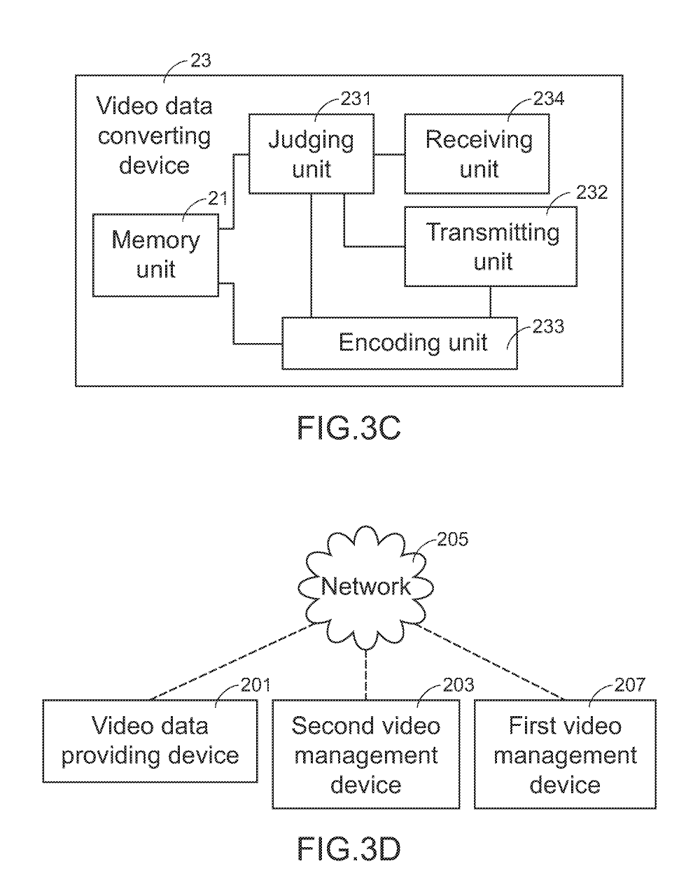

FIG. 3A is a schematic functional block diagram illustrating the connection between the video data providing device, the second video management device and the first video management device of the video transmission system according to another embodiment of the present invention. The first video management device 207 is in communication with the second video management device 203 through a wide area network (WAN) 211 for transmitting data. The video data providing device 201 is in communication with the second video management device 203 through a local area network (LAN) 209 for transmitting data. The video coding format supportable by the first video management device 207 is retrieved by the video data providing device 201 through the second video management device 203. After a video image is converted into video data by the video data providing device 201 according to the video coding format, the video data are transmitted to the second video management device 203 through the local area network 209. After the video data are received by the second video management device 203, the video data may be optionally compressed, encrypted or packed into a network packet. The processed video data are then transmitted to the first video management device 207 through the wide area network 211. According to the video coding format, the video data are decoded, decrypted or decompressed by the first video management device 207, so that the original video image provided by the video data providing device 201 is acquired.

FIG. 3B is a schematic functional block diagram illustrating an exemplary video data providing device of the video transmission system. As shown in FIG. 3B, the video data providing device 201 includes a video image generating device 22 and a video data converting device 23. The video image generating device 22 is used for providing the video image. The video data converting device 23 is electrically connected to the video image generating device 22.

An example of the video image generating device 22 includes but is not limited to a personal computer, a portable electronic device, a camera, an image pickup device, or the like. The video data converting device 23 is for example a dedicated converting device, an interface card, or a logic circuit attached on the video image generating device 22. After the video coding format supportable by the first video management device 207 is retrieved by the video data providing device 201 through the second video management device 203, a video image provided by the video image generating device 22 is converted into video data by the video data converting device 23 according to the video coding format. Afterwards, the video data are transmitted from the video data providing device 201 to the first video management device 207 through the network 205 and the second video management device 203.

Moreover, the video coding format may define an encryption/decryption protocol in order to provide an authentication mechanism between the first video management device 207 and the second video management device 203. Optionally, the video coding format further defines a compression/decompression algorithm in order to reduce the data size of the video data transmitted from the second video management device 203 to the first video management device 207 through the network 205.

In addition to the video image generating device 22 and the video data converting device 23, the video data providing device 201 further includes a memory unit 21. The memory unit 21 is electrically connected to the video image generating device 22 and the video data converting device 23 for recording the video coding format that is supportable by the first video management device 207. As shown FIG. 3B, the memory unit 21, the video image generating device 22 and the video data converting device 23 are separate components. Alternatively, the memory unit 21 may be integrated with the video image generating device 22 or the video data converting device 23. For example, as shown in FIG. 3C, the memory unit 21 is included in the video data converting device 23. Since the historical record associated with the previous connection could be preset or stored in the memory unit 21, the video coding format supportable by the first video management device 207 will be retrieved according to the historical record by the video data providing device 201. In this situation, the speed of inquiring the video coding format will be enhanced.

FIG. 3C is a schematic functional block diagram illustrating the video data converting device of another exemplary video data providing device of the video transmission system, in which the memory unit is included in the video data converting device. The video data converting device 23 is in communication with the first video management device 207 through the network 205 and the second video management device 203. The video image provided by the video image generating device 22 is converted into video data by the video data converting device 23 according to the video coding format. In this embodiment, the video data converting device 23 includes a judging unit 231, a transmitting unit 232, a receiving unit 234 and an encoding unit 233. The transmitting unit 232 is in communication with the first video management device 207 through the second video management device 203. The judging unit 231 is electrically connected to the transmitting unit 232 for retrieving and judging the video coding format. The encoding unit 233 is electrically interconnected between the transmitting unit 232 and the judging unit 231. According to the video coding format retrieved and judged by the judging unit 231, the video image provided by the video image generating device 22 (e.g. a personal computer, a portable electronic device, a camera, an image pickup device, or the like) is converted into video data by the encoding unit 233. The video data are sent to the transmitting unit 232, and then transmitted from the transmitting unit 232 to the first video management device 207 through the network 205 and the second video management device 203.

Please refer to FIG. 3C again. The video data converting device 23 further includes a receiving unit 234. The receiving unit 234 is electrically connected to the judging unit 231 for indirectly retrieving the video coding format through the second video management device 203 and the network 205. By the receiving unit 234, the setting of the video coding format is provided to the judging unit 231.

As shown in FIG. 3C, the memory unit 21 is included in the video data converting device 23. The memory unit 21 could record a manufacturer set value, a user set value or a historical record value associated with the video coding format supportable by the first video management device 207. Since the memory unit 21 is included in the video data converting device 23, the memory unit 21 is electrically connected with the judging unit 231 and the encoding unit 233.

The encoding unit 233 may have diversified functions. For example, in some embodiments, the encoding unit 233 further includes an encryption/decryption module (not shown) and a compression/decompression module (not shown). In addition, the first video management device 207 has a corresponding encryption/decryption module. By the encryption/decryption module of the encoding unit 233, the video image is converted into encrypted video data, and then the encrypted video data are transmitted to the first video management device 207 through the second video management device 203 and the network 205. That is, the encryption/decryption module provides an authentication mechanism among the participants of the video conference in order to prevent revealing data. By the compression module, the video image is converted into the compressed video data with a low data rate. For example, the video image may be compressed according to an H.261, H.263, H.263+ or H.264 video coding standard. As a consequence, the data amount of the video flow rate to be transmitted is reduced.

In the above embodiments, the video data providing device 201 including the video image generating device 22 and the video data converting device 23 is implemented by a logic circuit. Nevertheless, the function of converting the video image into the video data by the video data providing device 201 may be implemented by an application program. The application program is stored in storage media. When the application program is executed in a video data providing device 21, the video transmission method is implemented.

FIG. 3D is a schematic functional block diagram illustrating the connection between the video data providing device, the second video management device and the first video management device of the video transmission system according to a further embodiment of the present invention. The video transmission system includes a video data providing device 201, a first video management device 207 and a second video management device 203. The video data providing device 201, the first video management device 207 and the second video management device 203 are in communication with a network (e.g. a cable network or a wireless network, a homogeneous network or a heterogeneous network). The operating principles are similar to those described above, and are not redundantly described herein.

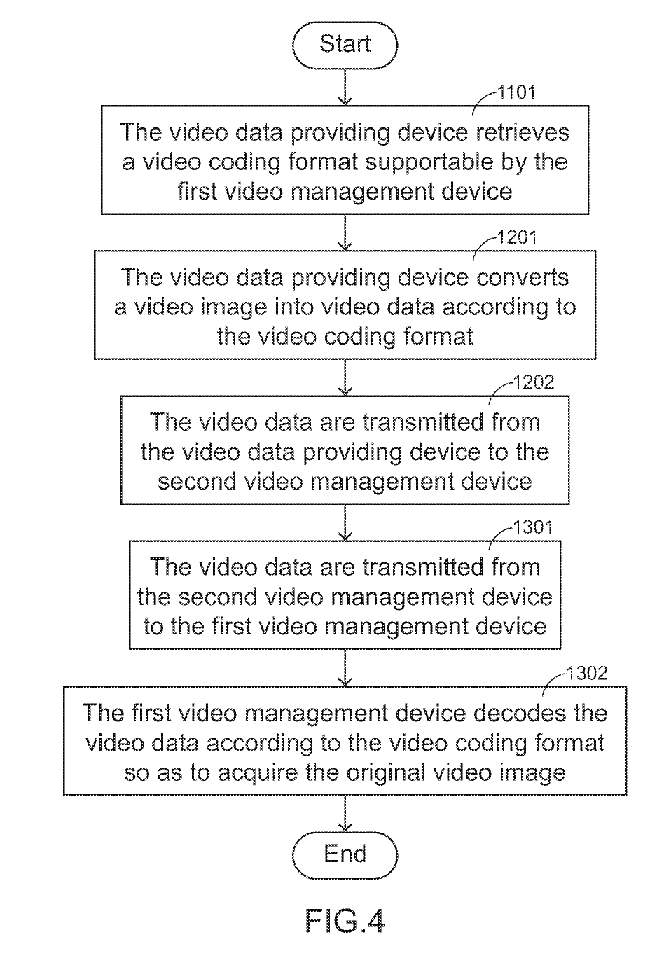

FIG. 4 is a flowchart illustrating a video transmission method according to an embodiment of the present invention.

In the step 1101, a video coding format supportable by the first video management device 207 is retrieved by the video data providing device 201. The video data providing device 201 is an integrated device; or alternatively, the video data providing device 201 includes two separate devices, i.e. video image generating device 22 and video data converting device 23. The video image generating device 22 and the video data converting device 23 are arranged in one-to-one, many-to-many or many-to-one manner. The data transmission between the video image generating device 22 and the video data converting device 23 are preformed through a wired/wireless network, a transmission cable, an interface card, an application program, or the like.

There are several possible approaches for retrieving the video coding format by the video data providing device 201. In a first approach, after the first video management device 207 and the second video management device 203 are in communication with each other, the video data providing device 201 inquires the video coding format sent from the first video management device 207 through the second video management device 203 and the network 205. In a second approach, there are a plurality of video coding formats supportable by the first video management device 207. According to a selection rule, a desired video coding format is selected by the second video management device 203 or the video data providing device 201. For example, if the video data providing device 201 receives more than one supported video coding format from the first video management device 207, a desired video coding format could be selected according to the user's setting (e.g. a predetermined priority sequence of several video coding formats) or the features of the video coding formats (e.g. compression ratios of the video coding formats). The selected video coding format is transmitted from the judging unit 231 to the encoding unit 233. In a third approach, the video coding format supportable by the first video management device 207 has been previously stored in the memory unit 21, which is electrically with the video image generating device 22 and the video data converting device 23. During the video conference, the video coding format is directly provided to the video data providing device 201 by the memory unit 21. The memory unit 21 is a separate component, or built-in the video image generating device 22 or the video data converting device 23. The memory unit 21 could record a set value (e.g. manufacturer set value, a user set value or a historical record value) associated with the video coding format supportable by the first video management device 207. The set value is sent to the judging unit 231 and the encoding unit 233.

In the step 1201, a video image is provided by the video data providing device 201. By a logic circuit or an application program, the video image is converted into video data according to the video coding format. For enhancing the data transmission speed, the video data could be compressed into compressed video data.

In the step 1202, the (compressed) video data are transmitted from the video data providing device 201 to the second video management device 203. The video data providing device 201 and the second video management device 203 are in communication with each other through a transmission interface such as a transmission cable, a local area network, a wide area network, a wired/wireless network, or the like.

In the step 1301, the video data are transmitted from the second video management device 203 to the first video management device 207. Depending on the connection between the second video management device 203 and the first video management device 207, the video data are optionally converted into network transmission data by the second video management device 203, and then the network transmission data are transmitted to the first video management device 207 through the (wide area) network. In a case that the authentication associated with the data transmission among the participants of the video conference is taken into consideration, the video data may be encrypted before the video data are transmitted from the second video management device 203. As a consequence, only the authenticated participants can realize the contents of the video data.

In the step 1302, the video data are decoded by the first video management device 207 according to the video coding format, so that the original video image is acquired. The decoding operation depends on the encoding operation. In a case that the video image is compressed as a compressed video data, the first video management device 207 will decompress the received video data. Whereas, in a case that the video image is encrypted as an encrypted video data, the first video management device 207 will decrypt the received video data. The video data are decoded by the first video management device 207 in order to restore the original video image.

By the first video management device 207 and other suitable device, the remote user could view the video image through software or a hardware component. Then, the video image is transmitted. It is noted that the above video transmission method could be applied to the remote video conference device in cooperation with at least one remote video data providing device 201.

From the above description, the video transmission method and the video transmission system of the present invention are capable of enhancing the data transmission speed and reducing the burden of the local video conference device.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video transmission method for use with a video data providing device, a first video management device and a second video management device, the video transmission method comprising steps of:
retrieving a video coding format by the video data providing device, wherein the video coding format is supportable by the first video management device;
converting a video image into a video data by the video data providing device according to the video coding format, and transmitting the video data to the second video management device; and
transmitting the video data from the second video management device to the first video management device, and decoding the video data by the first video management device according to the video coding format so as to acquire the video image.

2. The video transmission method according to claim 1 wherein the first video management device is inquired by the video data providing device through the second video management device, so that the video coding format is retrieved by the video data providing device.

3. The video transmission method according to claim 2 wherein the video coding format is sent from the first video management device or selected from a plurality of video coding formats supportable by the first video management device.

4. The video transmission method according to claim 1 wherein a set value including a manufacturer set value, a user set value or a historical record value is recorded in a memory unit and read by the video data providing device, so that the video coding format is retrieved by the video data providing device.

5. The video transmission method according to claim 1 wherein the first video management device and the second video management device are in communication with each other through a wide area network, and the video data providing device and the second video management device are in communication with each other through a local area network.

6. The video transmission method according to claim 1, further comprising steps of:
encrypting the video data as encrypted video data before the video data are transmitted to the first video management device; and
decrypting and decoding the encrypted video data by the first video management device according to the video coding format to acquire the video image after the encrypted video data are transmitted to the first video management device.

7. The video transmission method according to claim 1, further comprising steps of:
compressing the video data as compressed video data after the video image is converted into the video data; and
decompressing the compressed video data into the video data by the first video management device after the compressed video data are transmitted to the first video management device.

8. The video transmission method according to claim 1 wherein the video data are converted into network transmission data by the second video management device and the network transmission data are transmitted to the first video management device through a network.

9. A video transmission system for use with a network, the video transmission system comprising:
a first video management device in communication with the network, and supporting a video coding format;
a second video management device in communication with the network; and
a video data providing device in communication with the first video management device and the second video management device for retrieving the video coding format, converting a video image into video data according to the video coding format, and transmitting the video data to the second video management device, wherein the video data are transmitted from the second video management device to the first video management device, and the video data are decoded by the first video management device according to the video coding format so as to acquire the video image.

10. The video transmission system according to claim 9 wherein the video data providing device further comprises a memory unit for recording the video coding format supportable by the first video management device.

11. The video transmission system according to claim 9 wherein the video data providing device further comprises:
a video image generating device for providing the video image; and
a video data converting device electrically connected to the video image generating device for retrieving the video coding format, converting the video image into the video data according to the video coding format, and transmitting the video data to the second video management device through the network.

12. The video transmission system according to claim 9 wherein the video image is converted into the video data by a logic circuit in the video data providing device or an application program executed by the video data providing device.

13. The video transmission system according to claim 9 wherein the video coding format further defines:
a compression/decompression algorithm, thereby reducing the data size of the video data to be transmitted from the second video management device to the first video management device through the network; or
an encryption/decryption protocol, thereby providing an authentication mechanism between the first video management device and the second video management device.

14. A video data providing device for use with a first video management device and a second video management device, the video data providing device being in communication with the first video management device and the second video management device through a network, the video data providing device comprising:
a video image generating device for providing a video image; and
a video data converting device in communication with the video image generating device, the first video management device and the second video management device for retrieving a video coding format supportable by the first video management device, converting the video image into video data according to the video coding format, and transmitting the video data to the second video management device through the network,
wherein the video data are transmitted from the second video management device to the first video management device, and the video data are decoded by the first video management device according to the video coding format so as to acquire the video image.

15. The video data providing device according to claim 14 wherein the video data providing device further comprises a memory unit, which is in communication with the video image generating device and the video data converting device for recording the video coding format supportable by the first video management device.

16. The video data providing device according to claim 15 wherein the video coding format recorded in the memory unit includes a manufacturer set value, a user set value or a historical record value.

17. The video data providing device according to claim 14 wherein the video image is converted into the video data by a logic circuit in the video data converting device or an application program executed by the video data converting device.

18. The video data providing device according to claim 14 wherein the video image generating device and the video data converting device are in communication with each other through the network or a transmission cable.

19. The video data providing device according to claim 14 wherein the video data converting device comprises:
a transmitting unit in communication with the first video management device;
a judging unit in communication with the transmitting unit for retrieving the video coding format; and
an encoding unit in communication with the judging unit and the transmitting unit for converting the video image into the video data according to the video coding format, wherein the video data are transmitted from the encoding unit to the first video management device through the transmitting unit.

20. The video data providing device according to claim 19 wherein the video image is converted into the video data by compression or encryption.

21. A video data converting device for transmitting a video image according to a video coding format supportable by a first video management device, the video data converting device comprising:
a transmitting unit in communication with the first video management device;
a judging unit in communication with the transmitting unit for retrieving the video coding format; and
an encoding unit in communication with the judging unit and the transmitting unit for converting the video image into video data according to the video coding format, wherein the video data are transmitted from the encoding unit to the first video management device through the transmitting unit.

22. The video data converting device according to claim 21, further comprising:
a receiving unit, which is in communication with the first video management device and a second video management device through a network and electrically connected to the judging unit, wherein the video coding format is retrieved by the receiving unit through the network and the second video management device, and then transmitted to the judging unit; and
a memory unit, which is in communication with the judging unit and the encoding unit for recording the video coding format supportable by the first video management device.

23. The video data converting device according to claim 22 wherein the video coding format is read out from the memory unit by the judging unit.

24. The video data converting device according to claim 22 wherein the video coding format recorded in the memory unit includes a manufacturer set value, a user set value or a historical record value.

25. The video data converting device according to claim 21 wherein the encoding unit further comprises an encryption/decryption module for providing an authentication mechanism between the first video management device and the video data converting device.

26. The video data converting device according to claim 21 wherein the encoding unit further comprises a compression module for converting the video image into the video data by compression.

27. The video data converting device according to claim 21 wherein a plurality of video coding formats are supportable by the first video management device, and the retrieved video coding format is selected from the plurality of video coding formats by the judging unit according to a selection rule based on the features of the video coding formats or the user's setting.
